(19) United States
(12) Patent Application Publication
(10) Pub. No.: US 2013/0132170 A1
(43) Pub. Date: May 23, 2013

(54) SYSTEM AND METHOD FOR GENERATING PROOF OF PLAY LOGS IN A DIGITAL SIGNAGE ENVIRONMENT

(71) Applicants: Sriramakrishna Yelisetti, Sunnyvale, CA (US); Ashutosh A. Malegaonkar, Milpitas, CA (US)

(72) Inventors: Sriramakrishna Yelisetti, Sunnyvale, CA (US); Ashutosh A. Malegaonkar, Milpitas, CA (US)

(73) Assignee: Cisco Technology, Inc.

(21) Appl. No.: 13/300,409

(22) Filed: Nov. 18, 2011

(51) Int. Cl. G06Q 30/02

(52) U.S. Cl. 705/14.4

(57) ABSTRACT

An example method is provided and includes analyzing a digital advertisement configured for display on a digital sign; identifying a tag event that includes a keyword provided in the digital advertisement; identifying a time interval associated with the tag event; and recording the tag event and the time interval in a log. In more specific embodiments, the tag event further comprises an identification of a speaker in the digital advertisement. The digital advertisement can be identified by a token that may be associated with a hash having a time derived attribute.

### TECHNICAL FIELD

This disclosure relates in general to the field of digital signage and, more particularly, to generating proof of play logs in a digital signage environment.

### BACKGROUND

Advertising architectures have grown increasingly complex in communication environments. As advertising technologies increase in sophistication, proper coordination and efficient management of advertising content becomes critical. Typically, advertisers seek to confirm that their content was properly displayed from various locations. A network owner often forms a relationship that involves an advertiser, who seeks to broadcast particular content using the network owner's system displays. The ability to properly manage content transmissions and, further, to confirm that the actual broadcasting occurred presents a significant challenge to system designers, component manufacturers, advertising agencies, network owners/operators, and system administrators alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for generating proof of play logs in a digital signage environment in accordance with one embodiment of the present disclosure;

FIG. 2 is a simplified flow diagram illustrating potential operations associated with an embodiment of the communication system;

FIG. 3 is a simplified flow diagram illustrating potential operational details associated an embodiment of the communication system;

FIG. 4A is a table illustrating an example analytics log according to embodiments of the present disclosure;

FIG. 4B is a table illustrating an example query log according to embodiments of the present disclosure;

FIG. 4C is a table illustrating another example query log according to embodiments of the present disclosure;

FIG. 5 is a simplified flow diagram illustrating example operational steps associated with embodiments of the present disclosure;

FIG. 6 is a simplified flow diagram illustrating example operational steps associated with embodiments of the present disclosure; and

FIG. 7 is a simplified block diagram of a communication system for generating proof of play logs in a digital signage environment in accordance with another embodiment of the present disclosure.

### DETAILED DESCRIPTION OF EXAMPLE EMBODIMENTS

### Overview

An example method is provided and includes analyzing a digital advertisement configured for display on a digital sign; identifying a tag event that includes a keyword provided in the digital advertisement; identifying a time interval associated with the tag event; and recording the tag event and the time interval in a log. In more specific embodiments, the tag event further comprises an identification of a speaker in the digital advertisement. The digital advertisement can be identified by a token that may be associated with a hash having a time derived attribute.

In other embodiments, the method may include receiving a query from a network element, and recording the query in a query log. The query may be sent at a beginning of playing the digital advertisement and an additional query is sent at an end of playing the digital advertisement. In yet other implementations, the method may include receiving data associated with content provided in the digital advertisement; comparing the log with the data; and providing the data and the log to a proof of play storage element if the log correlates with the data (i.e., there is some degree of match between the data sets). The tag event can be used to verify whether certain content of the digital advertisement was played at a certain time interval. A speaker recognition protocol can be used to identify one or more speakers associated with the digital advertisement.

### EXAMPLE EMBODIMENTS

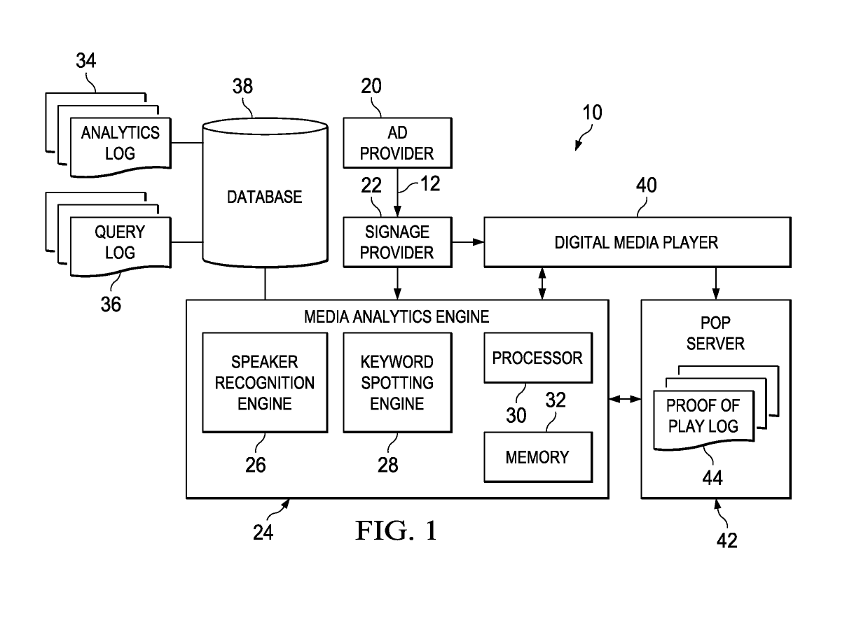

Turning to FIG. 1, FIG. 1 illustrates a communication system 10 for generating proof of play logs in a digital signage environment in accordance with one embodiment of the present disclosure. A network architecture may include an ad provider 20 that provides a digital advertisement to a signage provider 22. Ad provider 20 and signage provider 22 may be linked by a network 12, which may be wired or wireless. As used herein, a “digital advertisement” may include any suitable video, audio, images, animations, interactive video, tickers, graphics, text, or any type of media items that may be suitably rendered in a digital format. The digital advertisement (“ad”) can include content and associated tags. As used herein, the term “tag” encompasses topics, keywords, identification of speakers (e.g., speaker names, or any other parameter that distinguishes among speaker identities such as speaker 1, speaker 2, etc.), music, jingles, shapes, animations, and other elements, signatures, metadata, etc., that can characterize the content of the digital advertisement.

In example embodiments, ad provider 20 may be an advertising agency, or content creator/provider. Additionally, signage provider 22 may be operated by an agency that provides digital signage infrastructure for delivering digital content. The digital sign itself may include any suitable display, surface, television, endpoint device, user device, computer, or any other suitable rendering mechanism appropriate for displaying, playing, offering, etc. a digital advertisement. Hence, the actual ‘digital sign’ can include any suitable surface at which video data can be rendered for an audience (consumer, student, etc.). Note that as used herein in this Specification, the term ‘digital sign’ is meant to connote any element that is capable of delivering an image, video data, text, sound, audiovisual data, etc. to an end user. This would necessarily be inclusive of any panel, plasma element, television, monitor, computer interface, screen, electronic billboard, wall for projection activities, TelePresence devices (inclusive of TelePresence boards, panels, screens, surfaces, etc.) or any other suitable element that is capable of delivering/rendering/projecting such information. This could include panels or screens at concerts, in sports venues (e.g., scoreboards, banners, jumboTrons, baseball fences, etc.), or on the sides of buildings (e.g., in Times Square in New York, or downtown Tokyo, and other urban areas, where advertising is prevalent), or vehicle advertisements (e.g., where a truck or other types of vehicles are tasked with trolling certain streets and neighborhoods to deliver advertising content).

In certain implementations, the digital advertisement may be identified by a unique token. In an example embodiment, the token may be a hash (e.g., a small data set such as an index key that maps to a larger data set, such as an array) that includes a time derived attribute (e.g., time of generation of digital advertisement, time of scheduled play of digital advertisement, etc.). For example, the token may be T1-0010, signifying that the video-labeled T1 is to be played at 10 AM. In example embodiments, the token may be encrypted and/or tamperproof (or otherwise secure).

In operation, consider an example of a digital advertisement for a drink product that is in the form of a video. Assume, for the sake of this illustration, that the video is to be played at a stadium during a sports event at 10 PM. The video may be identified by a unique token: T1-10. The 2-minute video T1-10 shows a person enjoying a drink with music playing in the background. A tagline “drink safely” is displayed as text at approximately 20 seconds from the beginning of the video. A voiceover of a male speaker (speaker 1) may speak the words “drink safely” in the last few seconds of the video. A voiceover of a female speaker (speaker 2) may speak the words “always” at the very end of the ad, followed by a company jingle. The content of the video T1-10 may be characterized by the following tags: keyword 1: “drink”; keyword 2: “safely”; speaker 1; speaker 2; background music; and company jingle. Ad provider 20 may provide the digital advertisement, comprising the content and associated tags, to signage provider 22. According to example embodiments, ad provider 20 may provide the tags in any suitable format (e.g., as embedded metadata in the digital advertisement, as a separate file associated with the digital advertisement, etc.).

Signage provider 22 may push the digital advertisement to a media analytics engine 24 provisioned at any appropriate location. Media analytics engine 24 may include a speaker recognition engine 26, a keyword spotting engine 28, a processor 20, and a memory 32. In some embodiments, media analytics engine 24 may process the digital advertisement and extract appropriate tags therefrom. In other embodiments, media analytics engine 24 may process the digital advertisement and determine the occurrence of the tags. Hence, any identification of any appropriate tag may be considered a “tag event” as discussed herein. The tag event may include any suitable parameter, metadata, etc. (e.g., a time interval, a speaker identifier, etc.). Media analytics engine 24 is also configured to determine the corresponding time interval of the tag events and, subsequently, record the time and tag events in an analytics log 34. Tag events can include the appearance of keywords, which may include any suitable text matter, images, graphics, etc. in the digital advertisement. The tag events may also include the occurrence of audio tags (e.g., sounds, company jingles, speakers, spoken keywords, etc.) in the digital advertisement. Media analytics engine 24 may store analytics log 34 and a query log 36 in a database 38, which can be provisioned anywhere in the architecture.

Signage provider 22 may push the digital advertisement to a digital media player 40, which can play the digital advertisement at scheduled times. Only one digital media player 40 is illustrated in FIG. 1 for ease of description. Any number of digital media players may be included in communication system 10, where such media players can take any number of suitable forms (e.g., provisioned within a server, provisioned in an end user device, provisioned as part of a digital signage architecture, etc.). According to embodiments of the present disclosure, digital media player 24 may query media analytics engine 24 whenever the digital advertisement is played on digital media player 40.

At the end of playing the digital advertisement, digital media player 40 may also inform a proof of play server (POP server) 42 of the time of the playing of the digital advertisement. If the digital advertisement is played more than once, digital media player 40 may inform POP server 42 at the end of all plays, or alternatively at the end of each play. Digital media player 40 may also transmit data associated with the digital advertisement to POP server 42. POP server 42 may correlate the data from digital media player 40 with data from media analytics engine 24 to populate a proof of play log 44. “Data” as used herein refers to any type of numeric, audio, video, or script data, or any type of source or object code, or any other suitable information in any appropriate format that may be communicated from one point to another in electronic devices and/or networks. In particular examples, data may refer to digital advertisement tokens, tag events, time of tag events, time of query, etc. In example embodiments, POP server 42 may be operated by an audit firm or a third-party billing system, which the validates accuracy of proof of play log 44. In other example embodiments, POP server 42 may be operated by the digital signage network owner.

‘Proof of play’ is a concept used in digital signage to describe summary playback reports and/or raw play logs of content. Proof of play can be reflective of tearsheets in newspapers, click-through reports in pay-per-click marketing, etc. Proof of play typically reports which ads were actually displayed (e.g., played) on each screen (e.g., of a digital media player) and, further, when that broadcasting activity occurred.

Proof of play is an important aspect for digital signage as a reporting tool. It is particularly important when used for advertising, as advertisers seek proof that their content played on a specific sign (e.g., at a specific time). Many digital signage vendors provide proof of play logs for various purposes such as billing, performance, monitoring, auditing, etc. Some digital signage systems record what has been actually played, whereas others only record exceptional situations. Some digital signage systems automatically provide the proof of play log as part of the digital signage software installation, while others may require additional setup to enable the log (e.g., after installation). In regards to audited play logs, most digital signage playback devices produce raw play logs that track which advertisement played, the date it played, etc. In order to validate the accuracy of the entire reporting system, these play logs are commonly audited by a third party. These audits theoretically register the content that was previously played on the actual screen, and then the results can be compared to the play logs.

Digital signage has a strong advantage over simple broadcast media (e.g., television programming) because it can (theoretically) account for every advertisement played on every screen. In digital signage, near real-time tracking of each advertisement playing can be performed as an automated procedure. However, signage operators may not have the proper reporting mechanisms to provide appropriate accountability to the advertising marketers to whom they serve. For example, if one or more of the screens are functionally OFF, or disconnected from a digital media player, the proof of play reporting mechanisms would not detect this condition. This leads to an inaccurate count of ad plays, a distorted count of impressions, and incorrect conclusions in a post-campaign analysis.

In operation of a typical digital signage activity, an advertiser would pay a fee to a network owner (e.g., an owner of various video displays capable of rendering advertisements) for showing the advertiser's content. In many scenarios, an advertising agency would broker this relationship such that the content could be delivered to the advertising agency, which would contact various signage network owners for coordinating appropriate timeslots and locations to deliver the particular content. It would be impractical for the advertiser to verify each instance of the content being shown at various display locations. In some scenarios, the advertiser would only rely on a testament from the signage network owner as to whether the advertiser's particular content was properly displayed. However, because of the large monetary expenditures incurred in many advertising environments, the advertiser may seek reliable proof that the paid for content was actually shown. There can be various levels of proof of play in these scenarios.

One type of proof of play scenario focuses on scheduler functions in the digital signage system. The proof of play logs can track what is scheduled to play and, further, whether the digital signage system has successfully issued the command to play the content at the scheduled time. However, such a process can malfunction even after the digital signage system has successfully issued a command. For example, the display may be OFF, or the digital signage system may not be able to pull the content successfully from the source during the scheduled play time.

According to another proof of play scenario, snapshots of the content played are taken at fixed intervals and the snapshots are then pieced together in the proof of play report. However, this solution can have large scalability issues for both central processing unit (CPU) utilization and the storage capacity. The snapshots would be taken at the digital signage media player side. There are no snapshots for what is intended to play and, thus, no comparison between the intended digital advertisement and the advertisement, which was actually played. Auditors may have to manually match the snapshots with what was intended to play at a particular time. According to yet another proof of play scenario, video surveillance may be used to monitor the digital signs on the screens. This approach raises the same issues as the snapshot scenario, and may be even more expensive to implement.

Yet another level of proof of play may be as simple as providing a text log, which may include an electronic timestamp for when certain content was displayed. Proof of play logs generally conform to standards set by POPAI Digital Signage Network Playlog Standards. Proof of play logs can include a record of information created from the digital signage system players: reflecting content played, system performance, etc. A standardized log format, such as the format promulgated by the POPAI, can provide credibility to digital signage users by ensuring that the required information is present and, further, by making the sharing of such information easier amongst digital signage service providers. The current standardized format includes, at a minimum, a report name, a date of reporting, and at least one player report. A player is a device such as the digital media player that displays (or plays) the digital advertisement. Optionally, the report can add comments and general information of the digital signage network. The report is typically generated based on authorship, scheduling, management and distribution software, which may be developed by an independent software vendor, or a digital signage network operator.

A typical proof of play log is in an XML format, and it can include the following elements: name, date, and player, among other elements (such as network information, report provider, comment, etc.). The player element can encapsulate core information for content play activities happening at the player level. Each player may be uniquely identifiable by a suitable identification (ID), for example, a computer name that displays the digital advertisement. At a minimum, the player element may contain a list of play log entries with each entry corresponding to one content item played by the player at a given time period. Each content played may be identified by a unique content ID, and a start time and end time in a suitable format (e.g., YYYY-MM-DD Thh:mm:ssTZD, such as 1997-07-16T19:20:30+01:00).

Unfortunately, such log information is easy to falsify and, oftentimes, erroneous. Separately, while such a format may be enough in a closed system (e.g., within one enterprise where the logs can be trusted and not open to external tampering), the format may be insufficient in an open system. In an open system, where one enterprise generates the ads and pays for the display, and another enterprise displays the ads, the logs can be easy to intercept and then improperly modify. For example, the enterprise that displays the ads may intercept and modify the logs to incorrectly state that a particular ad was played at a specific time. An advertiser, or a third party auditor, may have no way to verify that the content (actually played) was indeed the content paid for (i.e., through inspecting the proof-of-play logs). In practical terms, proof of play logs should be trustworthy and tamperproof.

Communication system 10 can resolve these issues (and others) in providing a mechanism for proof of play of digital signage content using keyword spotting and speaker identification mechanisms. In example embodiments, ad provider 20 may provide a digital advertisement to signage provider 22. The digital advertisement may be identified by a unique token. Once an advertisement is being played, tag events (e.g., occurrence of keywords) and corresponding times may be known (either apriori or after the first time it has been played). A rogue element in the network may offset the start time with the tag event times (e.g., keyword appearance times) to generate a false (but seemingly legitimate) log, which the audit firms may not be able to invalidate. To overcome such tampering, the token identifying the digital advertisement may be securely encrypted. The more secure the token, the harder it may be to tamper with the proof of play logs associated with the token and the corresponding video.

In example embodiments, media analytics engine 24 may analyze the digital advertisement from signage provider 22, determine times of tag events occurring in the digital advertisement, and record the tag events and corresponding times in a suitable log (e.g., analytics log 34). (Note that the term ‘log’ encompasses any type of storage element, memory, database, repository, hard drive, or any other appropriate mechanism for storing data in the context of the proof of play activities discussed herein.) Digital media player 40 may play the digital advertisement and query media analytics engine 24 periodically for tag events and corresponding times, such as keywords, speakers, and time intervals. In one example embodiment, digital media player 40 may query media analytics engine 24 at the beginning of playing the digital advertisement, and at the end of playing the digital advertisement. In another example embodiment, digital media player 40 may query media analytics engine 24 at numerous time intervals (e.g., at each second interval) during playing of the digital advertisement.

Media analytics engine 24 may receive the queries from digital media player 40, and transmit data (e.g., from analytics log 34 to digital media player 40) in response to such queries. Media analytics engine 24 may keep track of which of the digital media players (e.g., digital media player 40) is sending the queries, as well as the time of the queries. In an example embodiment, media analytics engine 24 may store such queries, including digital media player identification (e.g., an IP address of the digital media player), query, time of the query, and the response data sent by media analytics engine 24 in query log 36. Digital media player 40 may store the responses from media analytics engine 24 in a suitable location, such as in hard drive storage, in a database, in a network element, etc. In example embodiments, digital media player 40 may maintain a history of the responses from media analytics engine 24 in any suitable location, for example, for verification purposes at a future time.

After playing the digital advertisement (e.g., immediately thereafter, a few minutes later, a few hours later, at a particular scheduled time, as specified by a third party auditor come etc.), digital media player 40 may push data about the digital advertisement to POP server 42. In an example embodiment, the data may include the digital media player identification (e.g., IP address), a token identifying the digital advertisement, and a time of playing the digital advertisement. For example, the data may be in the form of a play log. In another example embodiment, the data may additionally include data from analytics log 34 (e.g., tag events and corresponding times) obtained by digital media player 40 in response to its queries to media analytics engine 24.

POP server 42 may use an independent source (e.g., media analytics engine 24) to verify the accuracy of data from digital media player 40. In an example embodiment, POP server 42 may query media analytics engine 24 and obtain data (e.g., query log 36 and analytics log 34) in response to its query. POP server 42 may correlate the data from digital media player 40 with data from media analytics engine 24. If the data from digital media player 40 and media analytics engine 24 correlates, POP server 42 may populate proof of play log 44 with data attesting to this verification. In an example embodiment, the data from digital media player 40 may correlate with query log 36 if the time of the queries suitably matches with the time of playing the digital advertisement. In another example embodiment, the data from digital media player 40 may correlate with analytics log 34 if the data indicates that tag events and corresponding times provided by digital media player 40 suitably matches up with data in analytics log 34 provided by media analytics engine 24.

For example, assume that digital media player 40 starts playing digital advertisement T1 (which is 2 minutes long) at time 10:00:00 PM. At 10:00:00 PM, digital media player 40 sends a first query to media analytics engine 24, which logs the digital media player identification (e.g., IP address), the digital advertisement identification (e.g., T1), and the query time in query log 36. At 10:02:00 PM, when digital media player 40 ends playing the digital advertisement, digital media player 40 sends a second query to media analytics engine 24, which again logs the digital media player identification, the digital advertisement identification, and the query time in query log 36. Thus, query log 36 may include two entries for digital media player 40—a first entry for 10:00:00 PM and a second entry for 10:02:00 PM. Digital media player 40 sends data comprising the digital advertisement identification (e.g., T1) and time of playing (e.g., 10:00:00 PM) to POP server 42. POP server 42 retrieves query log 36 from media analytics engine 24, and compares the data from digital media player 40 with query log 36. A comparison may show that digital media player 40 indeed played digital advertisement T1 at 10:00:00 PM, corresponding to the first entry in query log 36. POP server 42 may then populate proof of play log 44 with the data from digital media player 40.

In another example, assume that digital media player 40 sends additional queries to media analytics engine 24, as it plays the digital advertisement. In response, media analytics engine 24 may transmit information from analytics log 34, such as tag events and corresponding times. For example, assume that the digital advertisement contained the keyword “Cisco UMI” with corresponding time codes 00:00:01, and 00:01:25 and keyword “Skype” with corresponding time codes 00:01:01, and 00:01:58. The “time code” can indicate a time interval in a specific format, such as HH:MM:SS. The time code may be provided in an absolute format (such as 10:00:01) or a relative format (such as 00:00:01 relative to start of the ad), or any other appropriate format, which may be based on particular needs.

Digital media player 40 can send a first query at 10:00:00 PM. In response to the query, media analytics engine 24 may respond with tag events and corresponding time codes for the first 10 seconds of the ad, which in this example would be the occurrence of keyword “Cisco UMI” with a corresponding time code 00:00:01. If digital media player 40 sends a second query at 10:01:00, media analytics engine 24 may respond with tag events and corresponding times for the first 1 minute and 30 seconds of the ad, which in the example would be the occurrence of keyword “Cisco UMI” and corresponding time codes 00:00:01, 00:01:25, and an occurrence of keyword “Skype” with a corresponding time code 00:01:01. At the end of playing the digital advertisement, digital media player 40 sends a third query at 10:02:00. In response, media analytics engine 24 may send the tag events and corresponding times in the ad. In one embodiment, query log 36 may include three entries for digital media player 40, with each entry identifying the digital media player (e.g., with an IP address), the digital advertisement token, and the time of query. In another embodiment, query log 36 may also include the respective responses sent by media analytics engine 24.

After it finishes playing the digital advertisement, digital media player 40 can push data comprising the digital media player identification, token identifying the digital advertisement (e.g., T1), time of playing (e.g., 10:00:00 PM), tag events, and corresponding times (e.g., responses from digital media player 24 indicating that keyword “Cisco UMI” corresponds to time codes 00:00:01, and 00:01:25 and keyword “Skype” corresponds to time codes 00:01:01 and 00:01:58) to POP server 42. POP server 42 retrieves query log 36 and analytics log 34 from media analytics engine 24, and cross-verifies whether the ad actually played or not. In an example embodiment, POP server 42 may compare the data from digital media player 40 with query log 36 and analytics log 34. A comparison may show that digital media player 40 indeed played digital advertisement T1 at 10:00:00 PM, corresponding to the first entry in query log 36. Also, subsequent entries in query log 36 and analytics log 34 indicate that tag events occurred as scheduled in the digital advertisement (e.g., as analyzed by media analytics engine 24 and populated in analytics log 34). POP server 42 may then populate proof of play log 44 with the data from digital media player 40.

According to another example embodiment, ad provider 20 may provide tags and corresponding time codes to signage provider 22, along with a digital advertisement. Media analytics engine 24 may generate a list of tags spotted in the content of the digital advertisement, along with their time interval. Note that the term “time interval” includes any type of timestamp, time code, or any other information indicative of timing or chronology. An initial report (e.g., analytics log 34) may be given back to ad provider 20. Next, at content playing time, signage provider 22 may start streaming the content to various digital media players. As digital media player 40 receives the content, media analytics engine 24 may begin its processing, and then start logging the tags in proof of play log 44. For example, the logging activity may be initiated by queries from digital media player 40. Ad providers and/or audit firms can cross-verify the tags in proof of play log 44 with analytics log 34. Hence, the infrastructure described above offers a mechanism to validate playing of the correct content at a specified time.

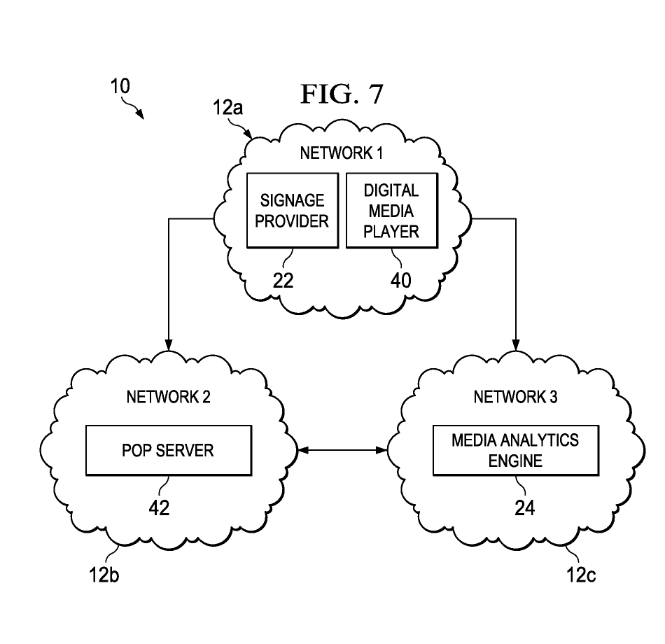

Turning to the infrastructure illustrated in FIG. 1, network 12 (and thereby extension to networks 12a, 12b, and 12c of FIG. 7) represents a series of nodes of interconnected communication paths for receiving and transmitting packets of information that propagate through communication system 10. One or more network elements may be connected or in communication with each other over various networks. Network 12 offers a communicative interface between any of the components of FIG. 1 and remote sites, and may be any local area network (LAN), wireless local area network (WLAN), metropolitan area network (MAN), wide area network (WAN), virtual private network (VPN), Intranet, or any other appropriate architecture or system that facilitates communications in a network environment. Network 12 may implement a UDP/IP connection and use a TCP/IP communication language protocol in particular embodiments of the present disclosure. However, network 12 may alternatively implement any other suitable communication protocol for transmitting and receiving data packets within communication system 10.

According to example embodiments, digital advertisements may be provided by ad provider 20 in various forms, including high definition (HD) or standard definition (SD) resolution, encrypted or unencrypted formats, with both potentially embedded and separate audio. Digital advertisements may be transmitted to signage provider 22 via various communication methods, including in-house feeds (e.g., through cameras positioned throughout a venue and routed through venue video control room), terrestrial channels (typically from local broadcast networks), and broadcast channels from cable or satellite providers.

Signage provider 22 may accommodate a variety of such digital advertisement inputs, and perform encoding, transcoding and other video processing to push the digital advertisement to various suitable elements, including digital media player 40, media analytics engine 24, etc. Signage provider 22 may provide a centralized management and operation of digital advertisement plays over network 12. For example, signage provider 22 may act as a single point of control for managing digital media player 40, for determining and delivering content (e.g., video, graphics, tickers), for defining display areas (e.g., zones and groups such as displays in bars, restaurants, clubs, luxury suites, etc.) and other functions.

Digital media player 40 is typically connected to (or is in communication with) one or more display screens and a content management server. According to an example embodiment, the content management server may be provisioned in conjunction with signage provider 22. One content management server (e.g., provisioned with signage provider 22) may support multiple digital media players, while one media player (e.g., digital media player 40) may support multiple display screens. In some embodiments, stand-alone digital signage devices may combine functions of display, media play, and content management in one device without any network connection to a centralized server. For example, signage provider 22 and digital media player 40 may be provisioned inside a single product, such as the Cisco® Digital Media Player 4310G. In other embodiments, signage provider 22 may be an application running on a central server and configured for controlling numerous digital media players with corresponding display devices.

Media analytics engine 24 and POP server 42 are network elements configured to perform various proof of play activities, as discussed herein. As used herein, the term “network element” is meant to encompass content management servers, digital media players, servers, computers, network appliances, servers, routers, switches, consoles, gateways, bridges, load-balancers, firewalls, endpoint devices, end user devices (e.g., smartphones, iPads, PDAs, etc.) processors, modules, proprietary devices, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information. In certain implementations, media analytics engine 24 may be provisioned inside multi-media devices such as the Cisco Experience Engine (MXE) 3500 media transformation platform. In other embodiments, media analytics engine 24 may be provisioned inside digital media player 40. In yet other embodiments, media analytics engine 24 may be a stand-alone device in communication with signage provider 22, digital media player 40, and/or POP server 42.

In one implementation, media analytics engine 24 and/or POP server 42 may include software to achieve (or to foster) the proof of play activities discussed herein. This could include the implementation of instances of speaker recognition engine 26 and/or keyword spotting engine 28 and any appropriate location. Additionally, each of these elements can have an internal structure (e.g., a processor, a memory element, etc.) to facilitate any of the operations described herein. In other embodiments, these proof of play activities may be executed externally to these elements, or included in some other network element to achieve the intended functionality. Alternatively, media analytics engine 24 and/or POP server 42 may include software (or reciprocating software) that can coordinate with other network elements in order to achieve the proof of play activities described herein. In still other embodiments, one or several devices may include any suitable algorithms, hardware, software, components, modules, interfaces, or objects that facilitate the operations thereof.

Database 38 may be a part of media analytics engine 24, it may be provided in a device in communication with media analytics engine 24, or it may be provided in any other suitable configuration based on particular needs. In some embodiments, POP server 42 may be provisioned in a server separate from signage provider 22 and digital media player 40. In other embodiments, POP server 42 may be provisioned in the same server and/or device as signage provider 22 and digital media player 42 (e.g., in a content management server). In yet other embodiments, POP server 42 may be provisioned in a network element together with media analytics engine 24. Components of system 10, including POP server 42, media analytics engine 24, etc. may be provisioned with appropriate network interfaces, ports, storage and processing elements (e.g., a processor) to perform their respective functions as described herein.

In one example embodiment, proof of play log 44 may be created and carried on a network that is different from the digital signage network, for example, to eliminate the possibilities of tampering with proof of play log 44. In another example embodiment, digital media players and analytics software (that are owned by the signage provider to detect play), in a digital signage network may return the proof of play records to an audit firm. In some embodiments, keyword/speaker detection, records transport processes, and query processes as described herein can be made tamperproof (for example, using analytics application programming interfaces (APIs), and encrypted tunnels for the transport, etc.).

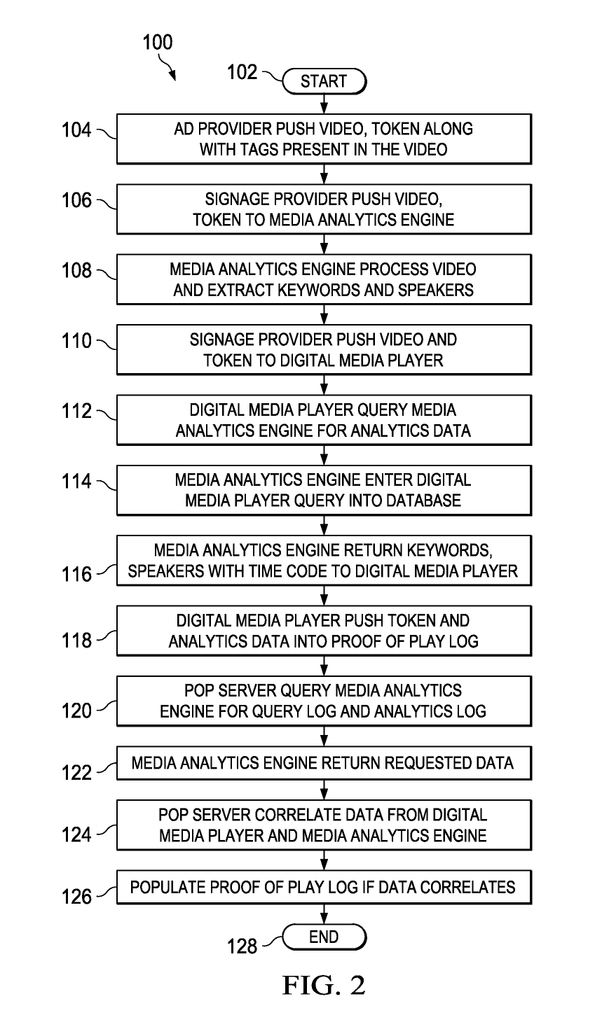

Turning to FIG. 2, FIG. 2 illustrates a flow diagram 100 of example operational activities that may be associated with embodiments of the present disclosure. For ease of description, FIG. 2 is described with reference to a video being provided as an example of a digital advertisement. The operations illustrated in FIG. 2 may be applied to any other forms of digital advertisements without departing from the broad scope of the present disclosure. Operations may start at 102 when a digital advertisement (e.g., video) is generated. At 104, ad provider 20 may push the video and corresponding identification token (e.g., T1), along with tags (e.g., keywords, speakers, music, etc. present in the video) to signage provider 22.

At 106, signage provider 22 may push the video and corresponding token to media analytics engine 24. Media analytics engine 24 may process the video and extract tags, such as keywords and speakers, at 108. For example, the video may have an audio track and a video track. In example embodiments, media analytics engine 24 may decouple the video and audio tracks and extract audio tags (such as spoken keywords) from the audio track. Textual keywords, and/or graphics may be extracted from the video track. Keyword spotting engine 28 may analyze the audio and/or video tracks and determine the time of occurrence of the specified keywords. Speaker recognition engine 26 may have speaker segmentation capabilities to determine when a particular speaker starts speaking, stops speaking, or when the next speaker begins to speak. At the end of the analysis of the audio track, speaker recognition engine 26 may determine information about the number of speakers, times when the respective speakers begin speaking, duration for which the respective speakers spoke, etc.

Referring back to the example of the “drink safely” video T1-10, keyword spotting engine 28 may determine that keywords “drink” and “safely” occur in the video at respective time codes 00:00:20, 00:01:50, and 00:01:51. Speaker recognition engine 26 may determine that speaker 1 speaks at time 00:01:50 through 00:01:51, and that speaker 2 speaks at time 00:01:53. Media analytics engine 24 may additionally determine that music plays from 00:00:00 through 00:01:50 in the video, and the company jingle occurs at time code 00:01:59.

At 110, signage provider 22 may push the video and token to digital media player 40. At 112, digital media player 40 may play the video. At the beginning of playing the video, digital media player 40 may query media analytics engine 24 for analytics data (i.e., data in analytics log 34). In an example embodiment, the query may include the identification of digital media player 40 (e.g., through its IP address. In another example embodiment, the identification of digital media player 40 may be achieved by a unique pre-assigned number, such as DMP01. The query may be provided in a hypertext transfer protocol (HTTP) request, and may also include the token (e.g., T1) identifying the video. In example embodiments, digital media player 40 may query media analytics engine 24 at the beginning of playing the digital advertisement, and at the end of the digital advertisement. In some embodiments, digital media player 40 may query media analytics engine 24 one or more times (e.g., at periodic intervals) during playing of the digital advertisement.

Media analytics engine 24 may enter such queries with corresponding times, along with digital media player identifiers in query log 36 (at 114). At 116, in response to the query from digital media player 40, media analytics engine 40 may return data from analytics log 34, such as tag events with corresponding time intervals, to digital media player 40. Media analytics engine 24 may record such responses in query log 36. At 118, after the video play is over, digital media player 40 may push a play log containing the video identification token to POP server 42. In some embodiments, digital media player 40 may additionally push analytics data, which were obtained in response to queries to media analytics engine 24, to POP server 42.

POP server 42 may perform a cross-verifying activity with the media analytics engine 24 to verify if digital media player 40 actually played the video. At 120, POP server 42 may query media analytics engine 24 for query log 36 and/or analytics log 34. At 122, media analytics engine 24 may return the requested data to POP server 42. At 124, POP server 42 may correlate data from digital media player 40 and media analytics engine 24. At 126, if data from digital media player 40 and media analytics engine 24 is found to correlate, POP server 42 may populate (e.g., record, store, write to, etc.) proof of play log 44 with the play log from digital media player 40. The operations may end at 128 in this example, where additional operations may be repeated for other digital advertisements and/or digital media players.

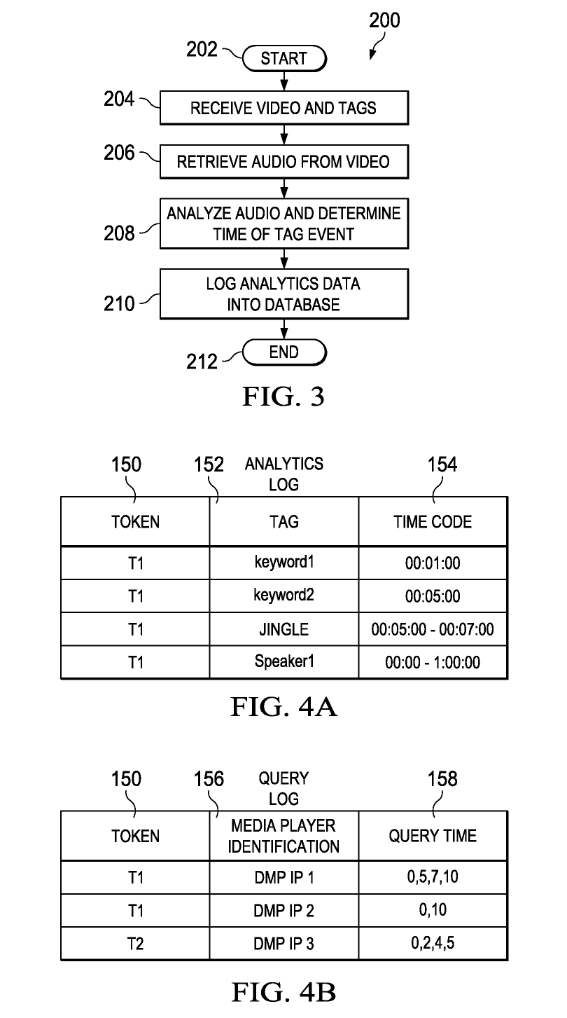

Turning to FIG. 3, FIG. 3 illustrates a flow diagram 200, which may be associated with embodiments of the present disclosure. For ease of description, FIG. 3 is described with reference to a video as an example of a digital advertisement. The operations may begin at 202 when media analytics engine 24 is activated. At 204, media analytics engine 24 can receive video and corresponding tags from signage provider 22. At 206, media analytics engine 24 retrieves audio from the video. At 208, media analytics engine 24 analyzes the audio and determines a time of occurrence of audio tag events. At 210, media analytics engine 24 can log tag events and a corresponding time of occurrence of tag events in analytics log 34 (e.g., within database 38). The operations may end at 212 and the operations may repeat for subsequent digital advertisements. Similarly, in other embodiments, media analytics engine 24 may also extract the video track (without the audio) from the video and determine tag events for graphic tags (such as text, images, tickers, etc.).

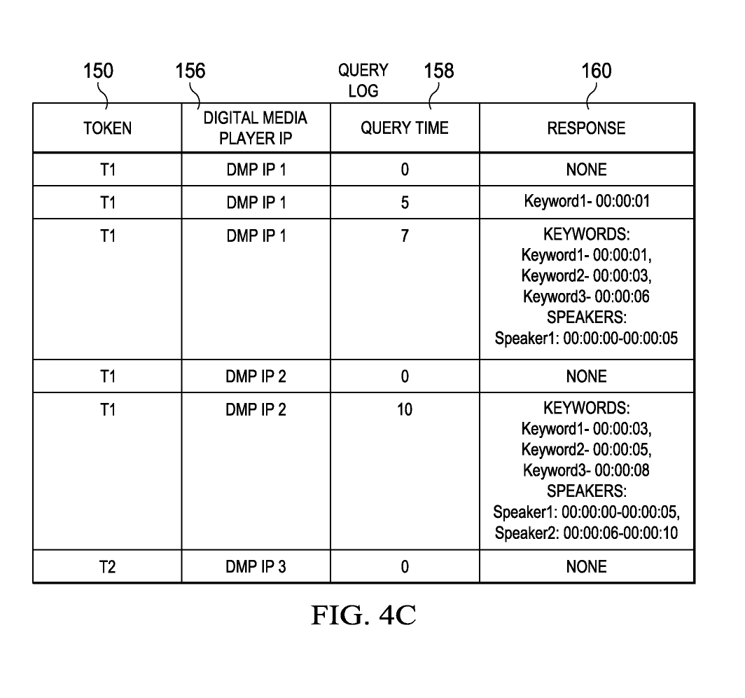

Turning to FIG. 4A, FIG. 4A is a table illustrating an example analytics log according to an embodiment of the present disclosure. A token category 150 indicates the identification token that uniquely identifies the digital advertisement to be played on digital media player 40. A tag category 152 indicates the tag (e.g., keyword, speaker, jingle, music, etc.) that characterizes the digital advertisement. A time code category 154 indicates the time of a tag event in a particular format. In the example illustrated in FIG. 4A, keyword 1 occurs at time code 00:01:00 in digital advertisement T1. Keyword 2 occurs at time code 00:05:00 in the same digital advertisement. The jingle occurs between time 00:05:00-00:07:00 in the digital advertisement. Speaker 1 speaks from 00:00 to 1:00:00 in the digital advertisement.

FIG. 4A illustrates a tabular format, while other formats, such as XML, CSV etc. may also be used without departing from the scope of the present disclosure. For example, the following format may also be used:
Content Name: <Cisco UMI Ad>
Total Keywords spotted: <30>
Keyword details:
   <“Cisco Umi”, “0.10 s: 4.20 s: 6.50 s . . . >
   <“skype”, “0.50 s: 2.40 s: 8.50 s . . . > etc.
Total Speakers Spotted: <3>
Speakers Spotted:
   <“Speaker1”, “20%”>
   <“Speaker2”, “70%”>
   <“music”, “10%”>

Turning to FIG. 4B, FIG. 4B is a table illustrating an example query log according to embodiments of the present disclosure. Token category 150 identifies the video being played by digital media player 40. A media player identification category 156 indicates the identification of the respective digital media player. For example, DMP IP1 may indicate one digital media player (e.g., with displays positioned at an entrance to a stadium), DMP IP 2 may indicate another digital media player (e.g., with displays positioned along a hallway in the stadium), and DMP IP 3 may indicate yet another digital media player (e.g., with displays positioned inside the food court in the stadium). A query time category 158 indicates the time(s) of the respective query. In the example illustrated in FIG. 4B, video T1 is played on DMP IP1, which queries media analytics engine 24 at 0, 5, 7 and 10 seconds. The same video T1 is played on DMP IP2, which queries media analytics engine 24 at 0 and 10 seconds. Another video T2 is played on DMP IP 3, which queries media analytics engine 24 at 0, 2, 4, and 5 seconds.

Turning to FIG. 4C, FIG. 4C illustrates another table associated with an example query log according to embodiments of the present disclosure. Token category 150 identifies the video being played by digital media player 40. Media player identification category 156 indicates the identification (e.g., digital media player IP) of the respective digital media player. Query time category 158 indicates the time intervals of the respective queries. A response category 160 indicates the responses sent by media analytics engine to the respective queries. In the example illustrated in FIG. 4C, video T1 is played on DMP IP1, which queries media analytics engine 24 at 0, 5, 7, and 10 seconds. Media analytics engine 24 may log no response to the query at time 0. Media analytics engine 24 may log keyword1 and the corresponding time code as a response to the query at time 5. Media analytics engine 24 may log keyword1, keyword2, keyword3, speakers, and corresponding time intervals to the query at time 7 and so forth. The same video T1 can be played on DMP IP2, which queries media analytics engine 24 at 0 and 10 seconds, where respective responses are logged in the query log. Another video T2 is played on DMP IP 3, which queries media analytics engine 24 at 0, 2, 4, and 5 seconds, and respective responses are logged in the query log. The example format shown in FIG. 4C is a tabular format, where other formats, such as XML, CSV, etc. may also be used.

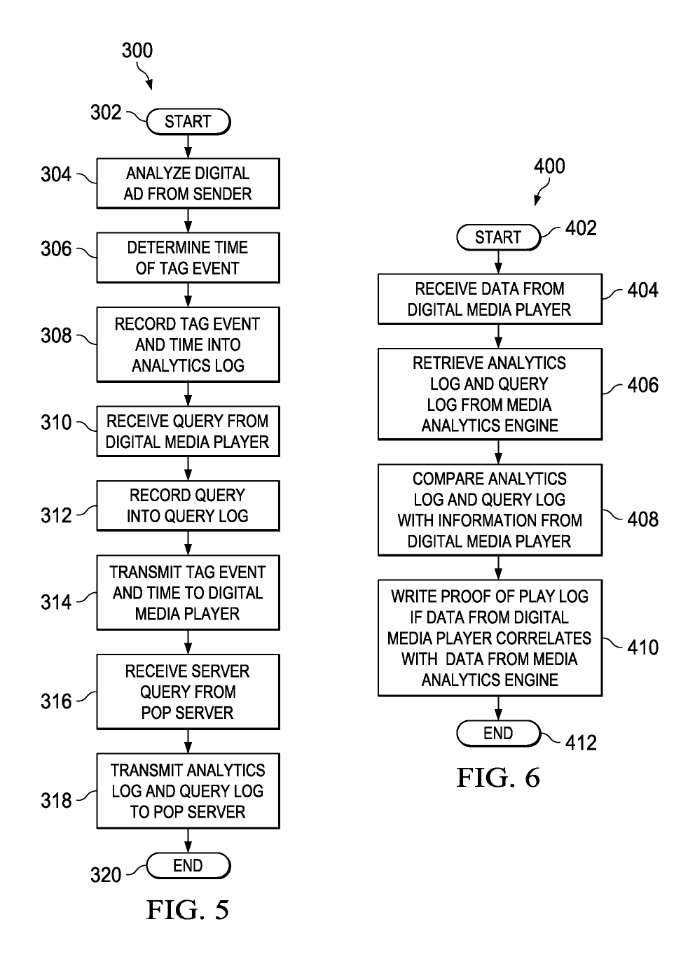

Turning to FIG. 5, FIG. 5 is a simplified flow diagram 300 showing example operational steps that may be associated with embodiments of the present disclosure. The operations may begin at 302 when communication system 10 is activated, for example, when ad provider 20 sends a digital advertisement to signage provider 22. At 304, media analytics engine 24 analyzes the digital advertisement from signage provider 22. At 306, media analytics engine 24 may determine the time of a tag event. At 308, media analytics engine 24 may record the tag event and the corresponding time in analytics log 34.

At 310, media analytics engine 24 may receive a query from digital media player 40. In an example embodiment, the query may include a token identifying the digital advertisement. In some embodiments, digital media player 40 may send a first query at a beginning of playing the digital advertisement, and a second query at an end of playing the digital advertisement. In other embodiments, digital media player 40 may periodically send queries during the time the digital advertisement is played.

At 312, media analytics engine 24 may record the query in query log 36. At 314, in response to the query, media analytics engine 24 may send tag events and a corresponding time to digital media player 40. At 316, media analytics engine 24 may receive a query from POP server 42. The query may include a request for data from query log 36 and analytics log 34 that pertains to the digital advertisement (e.g., identified by the corresponding token), and digital media player (e.g., identified by the corresponding digital media player identification). At 318, media analytics engine 24 may transmit analytics log 34 and query log 36 to POP server 42. The operations may end at 320 and may repeat for subsequent digital advertisements.

Turning to FIG. 6, FIG. 6 is a simplified flow diagram 400 illustrating example operational steps that may be associated with embodiments of the present disclosure. The operations may start at 402 when POP server 42 is activated. Subsequently, POP server 42 can receive data from digital media player 40 at 404. In an example embodiment, the data may include the token identifying the digital advertisement and a play log that includes the time of playing the digital advertisement. In yet another embodiment, the data may additionally include tag events and corresponding times obtained by digital media player 40 from media analytics engine 24.

At 406, POP server 42 may retrieve analytics log 34 and query log 36 from media analytics engine 24. In an example embodiment, the data retrieved by POP server 42 may include a subset of data in analytics log 34 and query log 36, for example, data that is relevant to the digital advertisement (identified by a corresponding token) and digital media player 40 (identified by a corresponding identification such as the IP address). At 408, POP server 42 may cross-verify the data from digital media player 40. In an example embodiment, POP server 42 may compare data from analytics log 34 and/or query log 36 with data from digital media player 24. If the data correlates at 410 (i.e., indicating some semblance of a match to a certain degree), POP server 46 may populate proof of play log 44.

In an example embodiment, the data from digital media player 40 to POP server 42 may indicate that a digital advertisement identified by token T1 was played from 08:00:00 to 08:05:00 and contained keywords 1, 2 and 3 at 00:00:01, 00:00:02, and 00:01:00 respectively. Analytics log 34 may indicate that digital advertisement T1 includes keywords 1, 2, and 3 at 00:00:01, 00:00:02 and 00:01:00, respectively, while query log 36 may indicate that digital media player 40 queried media analytics engine with digital advertisement token T1 at 08:00:00, 08:02:00 and 08:05:00. POP server 42 may compare the data from digital media player 40 with data from media analytics engine 24 and determine that digital media player 40 indeed played digital advertisement T1 from 08:00:00 to 08:05:00. Data from analytics log 34 may positively identify the digital advertisement as the one provided by ad provider 20 to signage provider 22. The operations of this particular example end at 412.

Turning to FIG. 7, FIG. 7 illustrates a simplified block diagram showing communication system 10 according to another embodiment of the present disclosure. Signage provider 22 and digital media player 40 may be provisioned within network 12a. Network 12a may be a digital signage network, controlled by a single entity such as the digital signage infrastructure provider. For example, network 12a may be a network of devices within a stadium. Signage provider 22 may push digital advertisements to several digital media players 40. Only one digital media player 40 is illustrated in FIG. 7 for ease of description; however, any number of digital media players may be included in the network.

POP server 42 may be provisioned in network 12b. Network 12b may be an auditor's network, which is controlled by a third party that oversees the proof of play reporting scheme. Media analytics engine 24 may be provisioned in yet another network 12c. Media analytics engine 24 may be controlled by ad provider 20, a third party auditor, or an independent service provider. Networks 12a-c may be enterprise networks, communication networks, or any other types of networks capable of transmitting data.

Note that in certain example implementations, the functions outlined herein may be implemented by logic encoded in one or more tangible, non-transitory media (e.g., embedded logic provided in an application specific integrated circuit (ASIC), digital signal processor (DSP) instructions, software (potentially inclusive of object code and source code) to be executed by a processor, or other similar machine, etc.). In some of these instances, memory (e.g., as shown in the FIGURES) can store data used for the operations described herein. This includes the memory being able to store code (e.g., software, logic, processor instructions, etc.) that are executed to carry out the activities described in this Specification.

A processor can execute any type of instructions associated with the data to achieve the operations detailed herein in this Specification. In one example, the processor (e.g., as shown in the FIGURES) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

Any of the memory items discussed herein (e.g., database, table, log, etc.) should be construed as being encompassed within the broad term ‘memory.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Note that with the example provided above, as well as numerous other examples provided herein, interaction may be described in terms of several network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures.

It is also important to note that the steps in the preceding flow diagrams illustrate only some of the possible signaling scenarios and patterns that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain server components, communication system 10 may be applicable to other protocols and arrangements (e.g., those involving any type of digital media player). Additionally, communication system 10 can have direct applicability in TelePresence environments such that proof of play and proof of effectiveness can be tracked during video sessions. A TelePresence screen can be used in conjunction with a server in order to capture what was played on the screen and, further, the audience's individual data associated with that rendering. Moreover, although communication system 10 has been illustrated with reference to particular elements and operations that facilitate the communication process, these elements and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
analyzing a digital advertisement configured for display on a digital sign;
identifying a tag event that includes a keyword provided in the digital advertisement;
identifying a time interval associated with the tag event; and
recording the tag event and the time interval in a log.

2. The method of claim 1, wherein the tag event further comprises an identification of a speaker in the digital advertisement.

3. The method of claim 1, wherein the digital advertisement is identified by a token.

4. The method of claim 3, wherein the token is associated with a hash having a time derived attribute.

5. The method of claim 1, further comprising:
receiving a query from a network element; and
recording the query in a query log.

6. The method of claim 5, wherein the query is sent at a beginning of playing the digital advertisement and an additional query is sent at an end of playing the digital advertisement.

7. The method of claim 1, further comprising:
receiving data associated with content provided in the digital advertisement;
comparing the log with the data; and
providing the data and the log to a proof of play storage element if the log correlates with the data.

8. The method of claim 1, wherein the tag event is used to verify whether certain content of the digital advertisement was played at a certain time interval.

9. The method of claim 1, wherein a speaker recognition protocol is used to identify one or more speakers associated with the digital advertisement.

10. Logic encoded in one or more non-transitory media that includes code for execution and when executed by a processor operable to perform operations comprising:
analyzing a digital advertisement configured for display on a digital sign;
identifying a tag event that includes a keyword provided in the digital advertisement;
identifying a time interval associated with the tag event; and
recording the tag event and the time interval in a log.

11. The logic of claim 10, wherein the tag event further comprises an identification of a speaker in the digital advertisement.

12. The logic of claim 10, wherein the digital advertisement is identified by a token.

13. The logic of claim 12, wherein the token is associated with a hash having a time derived attribute.

14. The logic of claim 10, the operations further comprising:
receiving a query from a network element; and
recording the query in a query log.

15. The logic of claim 14, wherein the query is sent at a beginning of playing the digital advertisement and an additional query is sent at an end of playing the digital advertisement.

16. The logic of claim 10, the operations further comprising:
receiving data associated with content provided in the digital advertisement;
comparing the log with the data; and
providing the data and the log to a proof of play storage element if the log correlates with the data.

17. The logic of claim 10, wherein the tag event is used to verify whether certain content of the digital advertisement was played at a certain time interval, and wherein a speaker recognition protocol is used to identify one or more speakers associated with the digital advertisement.

18. An apparatus, comprising:
a memory;
a processor coupled to the memory;
a keyword engine coupled to the processor; and
a speaker recognition engine coupled to the processor such that the apparatus is configured for:
analyzing a digital advertisement configured for display on a digital sign;
identifying a tag event that includes a keyword provided in the digital advertisement;
identifying a time interval associated with the tag event; and
recording the tag event and the time interval in a log.

19. The apparatus of claim 18, wherein the tag event further comprises an identification of a speaker in the digital advertisement, and wherein the digital advertisement is identified by a token associated with a hash having a time derived attribute.

20. The apparatus of claim 18, wherein the tag event is used to verify whether certain content of the digital advertisement was played at a certain time interval.
